(19) United States
(12) Patent Application Publication
(10) Pub. No.: US 2026/0051067 A1
(43) Pub. Date: Feb. 19, 2026

(54) IMAGE PROCESSING DEVICE, IMAGE PROCESSING METHOD, AND PROGRAM

(71) Applicants: Sony Group Corporation, Tokyo (JP); Sony Semiconductor Solutions Corporation, Kangawa (JP)

(72) Inventors: Hisashi Yoneyama, Tokyo (JP); Satoshi Tanaka, Kanagawa (JP)

(21) Appl. No.: 19/104,512

(22) PCT Filed: Sep. 15, 2023
(86) PCT No.: PCT/JP2023/033646

§ 371 Date: Feb. 18, 2025

(30) Foreign Application Priority Data
Sep. 30, 2022 (JP) 2022-158428

(51) Int. Cl. G06T 7/20; G06T 7/11; G06T 17/00; G06V 10/25; G06V 20/52

(52) U.S. Cl. CPC G06T 7/20; G06T 7/11; G06T 17/00; G06V 10/25; G06V 20/52; G06V 2201/07

(57) ABSTRACT

To improve convenience in an image processing device that detects entry of a moving object into a target area. The image processing device includes an entry detection unit. The entry detection unit of the image processing device detects the entry of the object into a detection target area on the basis of identification information in the detection target area. The detection target area in the entry detection unit is an area in which the object is to be detected. The specific area in the entry detection unit is information about a part of the object in the detection target area.

### FIELD

The present disclosure relates to an image processing device, an image processing method, and a program.

### BACKGROUND

In a factory or the like, a production line to perform assembly by an industrial robot is adopted. This industrial robot is applied to an operation of recognizing and gripping a component to be transported by a belt conveyor or the like and transporting the component to a workpiece position, or the like. In order to cause the industrial robot to perform such an operation, recognition of an object such as the component and grasp of the position or attitude of the object moving are required. In order to control this industrial robot, a system has been proposed to image an area where the object is transported by the belt conveyor or the like by a camera or the like to generate a moving image, for recognition of the object on the basis of the generated moving image. For example, a system has been proposed to detect an image of a plurality of reflectors (markers) applied to a moving body to detect entry of the moving body into a predetermined position (e.g., see Patent Literature 1).

### CITATION LIST

### Patent Literature

Patent Literature 1: JP 2020-035052 A

### SUMMARY

### Technical Problem

However, the conventional art described above requires the application of the reflectors to the moving body, and there is a problem that convenience is deteriorated.

Therefore, the present disclosure proposes an image processing device, an image processing method, and a program that provide improved convenience in the image processing device detecting entry of an object into a detection target area.

### Solution to Problem

An image processing device according to the present disclosure includes: an entry detection unit. The entry detection unit detects, based on identification information being information about a part of an object in a detection target area as a target area for detection of the object, entry of the object into the detection target area.

### BRIEF DESCRIPTION OF DRAWINGS

FIG. 1 is a diagram illustrating an exemplary configuration of a robotic arm according to an embodiment of the present disclosure.

FIG. 2 is a diagram illustrating an exemplary configuration of an image processing device according to a first embodiment of the present disclosure.

FIG. 3 is a diagram illustrating an exemplary configuration of a subsequent processing unit according to an embodiment of the present disclosure.

FIG. 4 is a diagram illustrating an example of detection of entry of an object according to the first embodiment of the present disclosure.

FIG. 5 is a diagram illustrating an example of generation of a range image according to an embodiment of the present disclosure.

FIG. 6 is a diagram illustrating an example of position/attitude estimation according to an embodiment of the present disclosure.

FIG. 7 is a diagram illustrating an exemplary procedure of a process in a control system according to an embodiment of the present disclosure.

FIG. 8 is a diagram illustrating an exemplary procedure of an entry detection process according to an embodiment of the present disclosure.

FIG. 9 is a diagram illustrating an exemplary configuration of an image processing device according to a second embodiment of the present disclosure.

FIG. 10 is a diagram illustrating an exemplary configuration of an image processing device according to a third embodiment of the present disclosure.

FIG. 11 is a diagram illustrating an example of a motion vector according to the third embodiment of the present disclosure.

FIG. 12 is a diagram illustrating an exemplary configuration of an image processing device according to a fourth embodiment of the present disclosure.

FIG. 13 is a diagram illustrating an example of a specific area according to the fourth embodiment of the present disclosure.

### DESCRIPTION OF EMBODIMENTS

Embodiments of the present disclosure will be described in detail below with reference to the drawings.

The description will be given in the following order. Note that in the following embodiments, the same portions are denoted by the same reference numerals, and repetitive description thereof will be omitted.
1. First Embodiment
2. Second Embodiment
3. Third Embodiment
4. Fourth Embodiment

### 1. First Embodiment

### Configuration of Robotic Arm

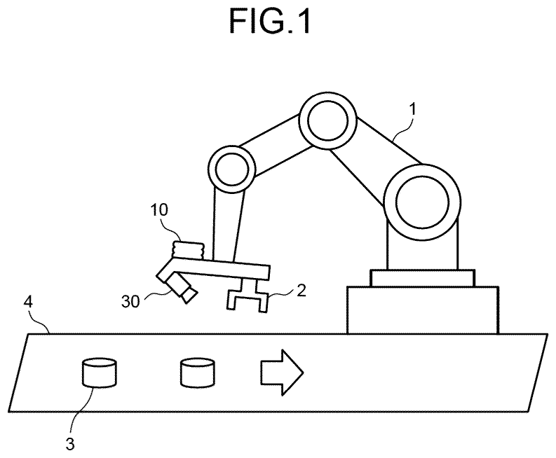

FIG. 1 is a diagram illustrating an exemplary configuration of a robotic arm according to an embodiment of the present disclosure. FIG. 1 is a diagram illustrating the robotic arm 1 according to the embodiment of the present disclosure. The robotic arm 1 is a device that performs work such as grasping and carrying a target object instead of a human arm. The robotic arm 1 of FIG. 1 includes a plurality of links that is turnably mounted. The links are portions of the robotic arm 1 corresponding to arm bones. The robotic arm 1 includes, at a front end, a gripping portion 2 that is arranged to grip an object to be transported. The robotic arm 1 is configured to extend/retract and swing on the basis of the control of a control device, which is not illustrated, so as to carry the gripped object to any position within a movable range.

FIG. 1 illustrates an example of the robotic arm 1 gripping the object. 3 transported by a belt conveyor 4 and carrying the object 3 to a predetermined position of a workpiece or the like. The robotic arm 1 causes a front end portion to stand by at a predetermined position in the vicinity of the belt conveyor 4 to make a movement when the object 3 moves into the movable range, and grips the object 3 by using the gripping portion 2.

The robotic arm 1 further includes a camera 30 and an image processing device 10 that are arranged at the front end. The camera 30 captures a moving image of an area in the vicinity of the belt conveyor 4 within the movable range of the robotic arm 1. The image processing device 10 recognizes the moving object 3, on the basis of the moving image captured by the camera 30, detects whether the object 3 has entered an area where the object 3 can be grasped by the gripping portion 2 of the robotic arm 1, and transmits the detection to a control unit (subsequent processing unit 20 which is described later) of the robotic arm 1. Therefore, the control unit causes the robotic arm 1 to move and causes the gripping portion 2 to drive to grip the object 3.

Here, a range (area) where the moving image is captured by the camera 30 is referred to as a detection target area. The detection target area is a target area for detecting the object 3 moving. The image processing device 10 detects entry of the object 3 into the detection target area and transmits a result of the detection to the subsequent processing unit 20 including the control unit of the robotic arm 1. The subsequent processing unit 20 detects a distance to the object 3 and an attitude of the object 3, and drives the robotic arm 1 and the gripping portion 2.

The image processing device 10 detects entry of the object 3 into the detection target area, on the basis of identification information that is information about a part of the object 3 in the detection target area. The identification information corresponds to, for example, information about a three-dimensional shape of a part of the object 3. This three-dimensional shape corresponds to, for example, a three-dimensional point cloud of the object. 3. As will be described later, the image processing device 10 generates, as the identification information, data about the three-dimensional point cloud from an image generated by the camera 30. Here, the three-dimensional point cloud is a set of points representing a three-dimensional shape of an object. The image processing device 10 detects whether the three-dimensional point cloud corresponding to the object 3 has entered the detection target area.

### Configuration of Image Processing Device

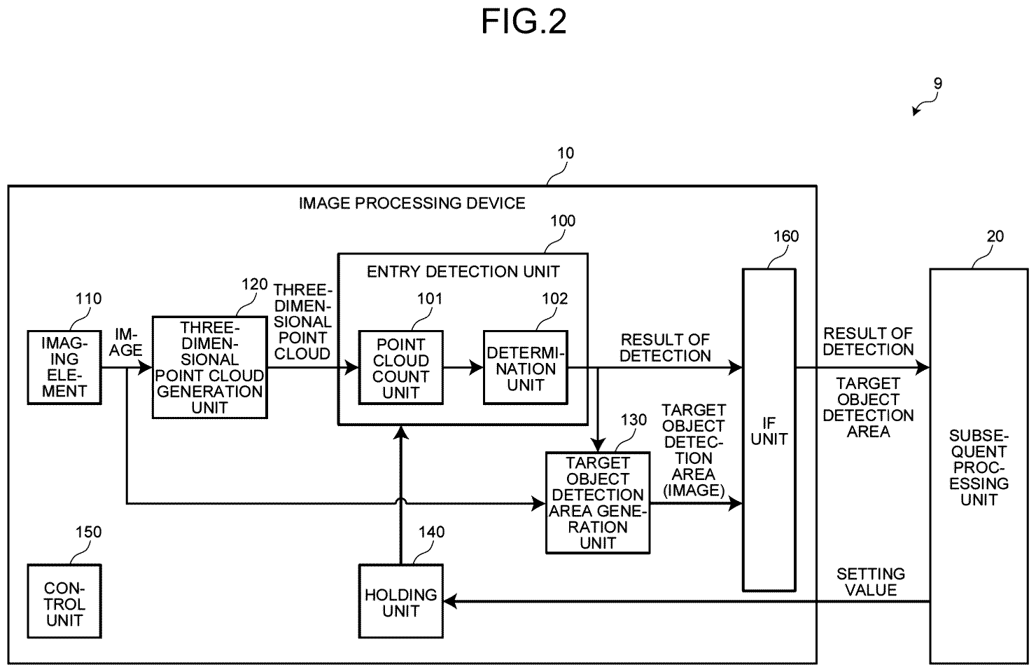

FIG. 2 is a diagram illustrating an exemplary configuration of the image processing device 10 according to a first embodiment of the present disclosure. FIG. 2 is a block diagram illustrating an exemplary configuration of the image processing device 10. The subsequent processing unit 20 is further illustrated in FIG. 2. Note that the image processing device 10 and the subsequent processing unit 20 constitute a control system 9. The image processing device 10 includes an imaging element 110, a three-dimensional point cloud generation unit 120, an entry detection unit 100, a target object detection area generation unit 130, an interface (IF) unit 160, a holding unit 140, and a control unit 150.

The imaging element 110 is configured to generate an image. The imaging element 110 is arranged in the camera 30 of FIG. 1 to generate an image of the detection target area. For the imaging element 110, for example, a complementary metal oxide semiconductor (CMOS) imaging element can be applied. The imaging element 110 sequentially generates images (frames) at a predetermined frame frequency and outputs the images to the three-dimensional point cloud generation unit 120. Note that each of the images generated by the imaging element 110 corresponds to the image of the detection target area described above. The image of the detection target area is referred to as a detection target area image. Note that the imaging element 110 is an example of a “sensor” of the present disclosure.

The three-dimensional point cloud generation unit 120 is configured to generate the three-dimensional point cloud that is the identification information described above. The three-dimensional point cloud generation unit 120 generates the three-dimensional point cloud from the detection target area image generated by the imaging element 110, and outputs the three-dimensional point cloud to the entry detection unit 100. The three-dimensional point cloud generation unit 120 is capable of generating a range image from the image generated by the imaging element 110 to generate the three-dimensional point cloud on the basis of the range image. Here, the range image is an image in which distance information is reflected for each pixel. Details of the generation of the range image will be described later. Note that a known method can be applied as a method of generating the three-dimensional point cloud from the range image. Note that the three-dimensional point cloud generation unit 120 is an example of a “identification information generation unit” of the present disclosure.

The entry detection unit 100 is configured to detect the entry of the object 3 into the detection target. area, on the basis of the identification information described above. The entry detection unit 100 detects the entry of the object 3 into the detection target area, on the basis of the three-dimensional point cloud generated by the three-dimensional point cloud generation unit 120. In addition, the entry detection unit 100 outputs a result of the detection to the IF unit 160. The entry detection unit 100 includes a point cloud count unit 101 and a determination unit 102.

The point cloud count unit 101 is configured to count the number of point clouds in the three-dimensional point cloud generated by the three-dimensional point cloud generation unit 120. The point cloud count unit 101 outputs the number of the point clouds counted, to the determination unit 102. Note that the point cloud count unit 101 is capable of counting the number of point clouds included within a predetermined distance range, of the three-dimensional point cloud. The predetermined distance range is a range closer to a distance to a target object to be measured. For example, a range closer to the distance to the object 3 placed on the belt conveyor 4 can be applied to the predetermined distance range. Limiting an area of point clouds to be counted by the point cloud count unit 101 within the predetermined distance range makes it possible to improve the accuracy of the detection of the object 3. The predetermined distance range is supplied by the holding unit 140.

The determination unit 102 is configured to determine whether the object 3 has entered the detection target area, on the basis of the number of point clouds from the point cloud count unit 101. When determining that the object 3 has entered the detection target area, the determination unit 102 outputs the detection of the entry of the object 3 into the detection target area to the IF unit 160, as the result of the detection by the entry detection unit 100. For example, the determination unit 102 is capable of comparing the number of point clouds with a predetermined threshold to determine the entry of the object 3. Specifically, the determination unit 102 is capable of determining the entry of the object 3 when the number of point clouds is equal to or larger than the predetermined threshold. The predetermined threshold is supplied by the holding unit 140.

The target object detection area generation unit 130 is configured to generate a target object detection area that is information about an area of the object 3 whose entry is detected. The target object detection area generation unit 130 of FIG. 2 generates an image of an area including the object 3 of the image of the detection target area, as the target object detection area. Furthermore, the target object detection area generation unit 130 outputs the generated target object detection area, to the IF unit 160.

The IF unit 160 is configured to interact with the subsequent processing unit 20. The IF unit 160 outputs the result of the detection from the entry detection unit. 100 and the target object detection area from the target object detection area generation unit 130, to the subsequent processing unit 20.

The holding unit 140 is configured to hold the predetermined distance range and the predetermined threshold which are described above, and output the predetermined distance range and the predetermined threshold to the entry detection unit 100. The holding unit 140 holds the predetermined distance range and the predetermined threshold that are output as setting values from the subsequent processing unit 20.

The control unit 150 is configured to control the entire image processing device 10.

### Configuration of Subsequent Processing Unit

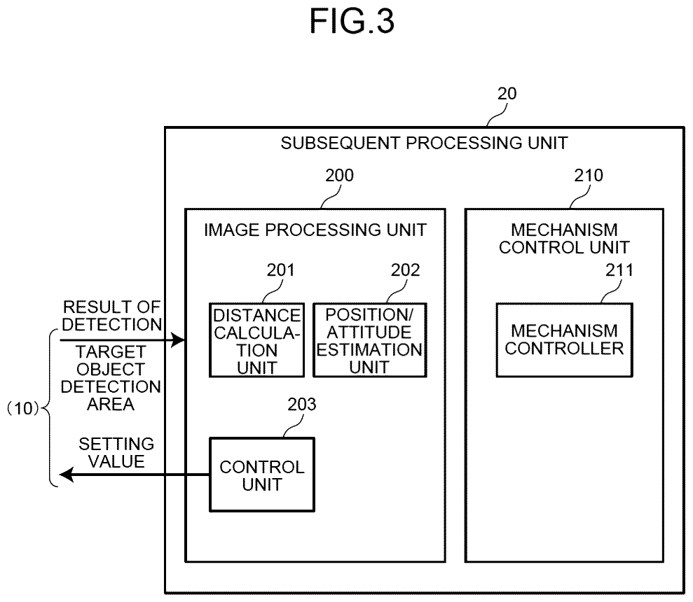

FIG. 3 is a diagram illustrating an exemplary configuration of the subsequent processing unit 20 according to an embodiment of the present disclosure. FIG. 3 is a block diagram illustrating the exemplary configuration of the subsequent processing unit 20. The subsequent processing unit 20 includes an image processing unit 200 and a mechanism control unit 210.

The image processing unit 200 performs processing on the basis of the target object detection area output from the image processing device 10. The image processing unit 200 includes a distance calculation unit 201, a position/attitude estimation unit 202, and a control unit 203.

The distance calculation unit 201 is configured to calculate the distance to the object 3 whose entry has been detected. The position/attitude estimation unit 202 is configured to estimate a position/attitude of the object 3 whose entry has been detected. When the result of the detection of the object 3 is input from the image processing device 10, each of the distance calculation unit 201 and the position/attitude estimation unit 202 starts processing.

The control unit 203 is configured to control the entire image processing unit 200. Furthermore, the control unit 203 generates the setting values and outputs the setting values to the holding unit 140 of the image processing device 10.

The mechanism control unit 210 is configured to control the robotic arm 1. The mechanism control unit 210 includes a mechanism controller 211.

The mechanism controller 211 is configured to control the robotic arm 1 and the gripping portion 2 on the basis of the distance to the object 3 and the position of the object 3 that are output from the image processing unit 200.

### Detection of Entry of Object

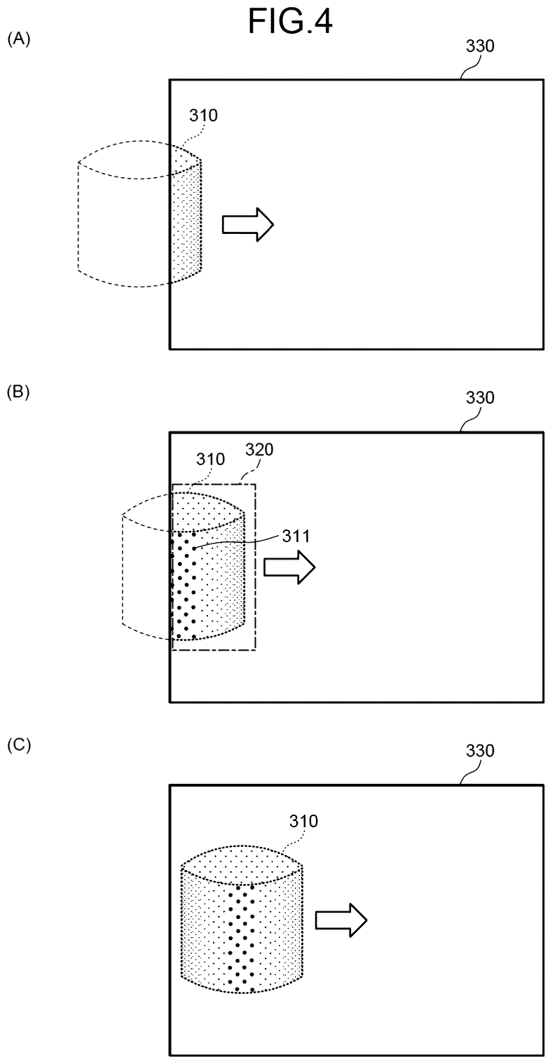

FIG. 4 is a diagram illustrating an example of detection of entry of an object according to the first embodiment of the present disclosure. FIG. 4 is a diagram illustrating detection of the entry of the object 3 by the image processing device 10. In FIG. 4, a rectangular area represents a detection target area 330. A dot-hatched area represents a three-dimensional point cloud 310 of the object 3. A white arrow indicates a moving direction of the object 3.

In (A) of FIG. 4, entry of an end portion of the three-dimensional point cloud 310 of the object 3 into the detection target area 330 is illustrated. In (B) of FIG. 4, entry of a half or more of the three-dimensional point cloud 310 of the object 3 into the detection target area 330 is illustrated. In (C) of FIG. 4, entry of the entire three-dimensional point cloud 310 of the object 3 into the detection target area 330 is illustrated. As described above, the point cloud count unit 101 of the entry detection unit 100 counts the number of three-dimensional point clouds of the object 3. Then, when the number of three-dimensional point clouds of the object 3 is equal to or larger than the predetermined threshold, the determination unit 102 determines that the object 3 has entered the detection target area 330. In (B) of FIG. 4, the number of three-dimensional point clouds equal to or larger than the threshold is illustrated. In this situation, the determination unit 102 determines that the object 3 has entered the detection target area 330.

Furthermore, in (B) of FIG. 4, the target object detection area generation unit 130 generates the target object detection area. A rectangular shape represented by an alternate long and short dash line in (B) of FIG. 4 represents a target object detection area 320. As illustrated in FIG. 4, the target object detection area generation unit 130 is an area including the detected object 3. The target object detection area generation unit 130 according to the first embodiment of the present disclosure clips an image of the area corresponding to the target object detection area 320, from the detection target area 330, and generates the target object detection area (image).

### Generation of Range Image

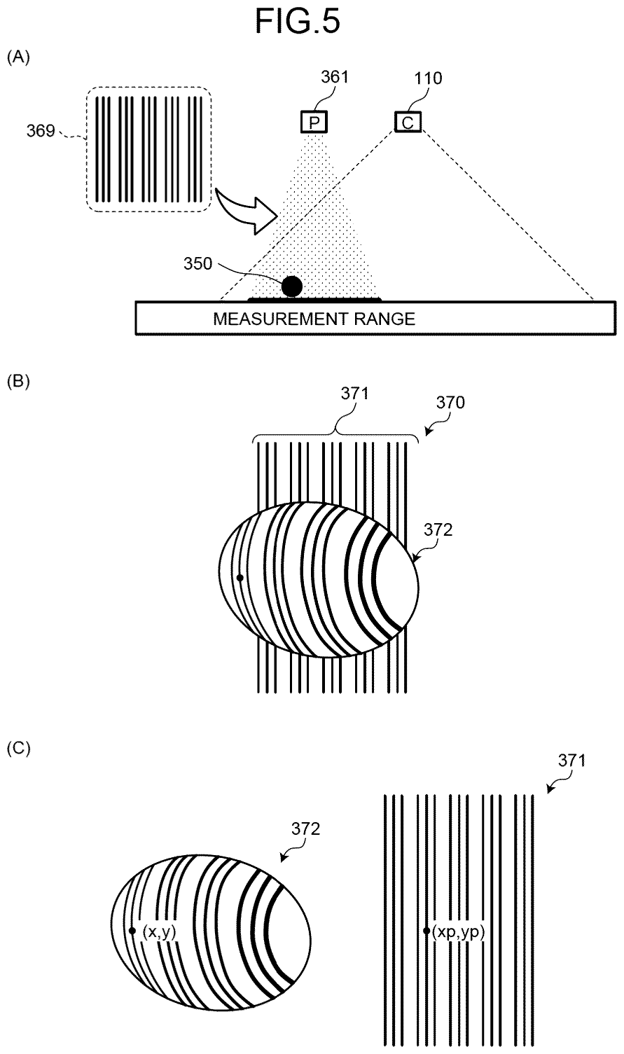

FIG. 5 is a diagram illustrating an example of generation of the range image according to an embodiment of the present disclosure. FIG. 5 is a diagram illustrating an example of generation of the range image in the three-dimensional point cloud generation unit 120. First, the three-dimensional point cloud generation unit 120 calculates a distance to a target object to be measured. The distance to the target object to be measured is allowed to be calculated on the basis of the principle of triangulation through detection of a feature point from a pattern projected on the target object to be measured and association between the feature point and a feature point on a captured image on the basis of a feature amount of the detected feature point.

In (A) of FIG. 5, an example is illustrated in which pattern light 369 from a projector 361 is projected onto a target object 350 to be measured and a captured image is generated by the imaging element. 110. In addition, in the example of FIG. 5, the pattern light 369 includes a plurality of vertical lines. When pattern light 369 configured as described above is projected from the projector 361 and captured by the imaging element 110 at a predetermined distance from the projector 361, a captured image depending on a distance (three-dimensional shape) to the target object 350 to be measured can be obtained. Note that a captured image where there is not the target object 350 to be measured is referred to a projection image. This projection image is an image based on the pattern light 369.

In (B) of FIG. 5, an example of the captured image 370 is illustrated. An image 372 changed according to the shape of the target object 350 to be measured is formed in the area of the target object 350 to be measured of the captured image 370, and an image (projection image 371) based on the pattern light 369 is formed in the other area. The three-dimensional point cloud generation unit 120 sets the feature point in the image 372. This feature point can be set to an edge or the like of a projected pattern. A black point in (B) of FIG. 5 represents an example of the feature point. Next, the three-dimensional point cloud generation unit 120 calculates feature amounts from pixel values around the set feature point. Next, the three-dimensional point cloud generation unit 120 associates a pixel of the projection image 371 with the set feature point, both of which have the same feature amount. In (C) of FIG. 5, an example is illustrated in which a feature point (x, y) of the image 372 is associated with a point (xp, yp) of the projection image 371.

Next, the three-dimensional point cloud generation unit 120 calculates a distance between the feature point (x, y) and the point (xp, yp) on the image. Next, the three-dimensional point cloud generation unit 120 calculates a distance (three-dimensional shape) to the target object 350 to be measured, from the distance between the feature point (x, y) and the point (xp, yp) on the image by applying the principle of triangulation. Repetition of such processing allows generation of the range image.

### Position/Attitude Estimation

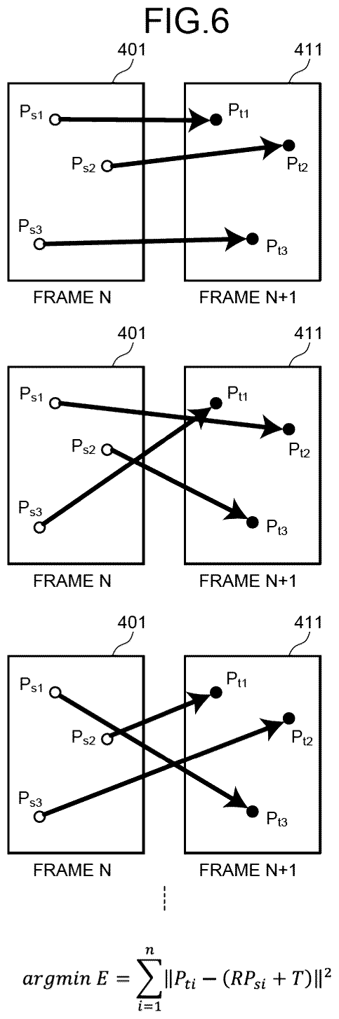

FIG. 6 is a diagram illustrating an example of position/attitude estimation according to an embodiment of the present disclosure. FIG. 6 is a diagram illustrating an example of position/attitude estimation in the position/attitude estimation unit 202. In addition, FIG. 6 illustrates an example of position/attitude estimation based on an iterative closest point (ICP) algorithm. The position/attitude estimation can be performed by calculating a rotation matrix and a translation matrix that minimize a sum of squares from a positional relationship of three-dimensional point clouds between frames. Calculation of the sum of squares and movement of a point cloud are repeated until a convergence condition is satisfied. Specifically, when a three-dimensional point cloud in a frame N is defined as Pₛₙ and a three-dimensional point cloud in a frame N+1 is defined as Pₜₙ, matrices R and T in which, in a correspondence relationship between certain Pₛₙ and Pₜₙ, a difference value between Pₛₙ and Pₜₙ to which a rotation matrix (R) and a translation matrix (T) are applied is minimized (a sum of squares of a distance between corresponding points) are obtained. A formula in FIG. 6 represents a calculation formula to calculate the sum of squares of the distance between the corresponding points.

In general, variations of the corresponding points are defined within a prescribed range. FIG. 6 illustrates the variations of the corresponding points in a frame 401 having a point cloud of Pₛ₁-Pₛ₃ and corresponding to the frame N and a frame 411 having a point cloud of Pₜ₁-Pₜ₃ and corresponding to the frame N+1. The calculation of the sum of squares of the distance between the corresponding points and the movement of the point cloud are repeatedly performed until the sum of squares satisfies the convergence condition. This configuration makes it possible to calculate the rotation matrix (R) and the translation matrix (T), and the position/attitude of the object 3 represented by the three-dimensional point cloud can be estimated.

### Process in Control System

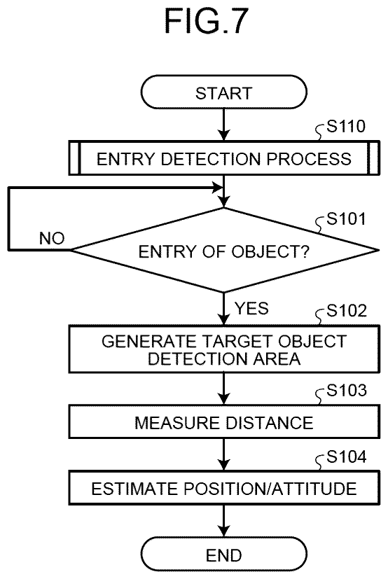

FIG. 7 is a diagram illustrating an exemplary procedure of a process in a control system according to an embodiment of the present disclosure. FIG. 7 is a flowchart illustrating an exemplary procedure of a process in the control system 9 of FIG. 1. First, the image processing device 10 performs an entry detection process (Step S110). As a result, when the entry of the object is detected (Step S101, Yes), the target object detection area generation unit 130 of the image processing device 10 generates the target object detection area (Step S102). Next, the distance calculation unit 201 of the mechanism control unit 210 performs distance measurement for the object 3 on the basis of the target object detection area (Step S103). Next, the position/attitude estimation unit 202 of the mechanism control unit 210 estimates the position/attitude of the object 3 (Step S104). Thereafter, the mechanism controller 211 of the mechanism control unit 210 controls the robotic arm 1 and the gripping portion 2 on the basis of the distance to the object and the position and the attitude of the object.

### Entry Detection Process

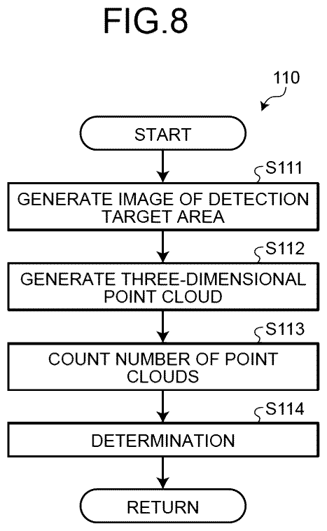

FIG. 8 is a diagram illustrating an exemplary procedure of the entry detection process according to an embodiment of the present disclosure. FIG. 8 is a flowchart illustrating an exemplary procedure of the entry detection process. Note that the process of FIG. 8 corresponds to the processing in Step S110 in FIG. 7.

First, the imaging element 110 generates an image of the detection target area (Step S111). Next, the three-dimensional point cloud generation unit 120 generates the three-dimensional point cloud from the image of the detection target area (Step S112). Then, the point cloud count unit 101 of the entry detection unit 100 counts the number of point clouds in the three-dimensional point cloud (Step S113). Next, the determination unit 102 of the entry detection unit 100 determines whether the object 3 has entered the detection target area, on the basis of the number of point clouds (Step S114), and detects the entry of the object 3. Thereafter, the entry detection unit 100 outputs a result of the detection, and the process returns to the first step. Note that Step S110 is an example of an “entry detection procedure”of the present disclosure.

In this way, the image processing device 10 according to the first embodiment of the present disclosure generates the identification information for the object 3 on the basis of the image of the detection target area, and detects the entry of the object 3 into the detection target area on the basis of the identification information. The entry of the object 3 is allowed to be detected without using a marker or the like for recognizing the shape of the object 3, for improved convenience. In addition, it is possible to stop the processing of position/attitude estimation by the position/attitude estimation unit 202 in a period in which the entry of the object 3 is not detected by the image processing device 10, reducing power consumption of the control system 9.

In addition, adjusting the threshold for determination in the determination unit 102 facilitates adjustment of the shape of the image area of the object 3 upon determination of the entry. For example, it is possible to adopt a configuration in which the threshold is adjusted to detect the entry when the entire object 3 enters the detection target area. In this configuration, the accuracy in the position/attitude estimation of the object 3 can be improved. This is because, when the position/attitude estimation is performed while only a part of the target object to be measured is in the detection target area, an error occurs in the position/attitude estimation due to insufficient three-dimensional point cloud. In addition, for example, it is also possible to adopt a configuration in which entry is detected when a part of the object 3 enters the detection target area. This configuration enables high-speed detection of the entry of the object 3.

### 2. Second Embodiment

In the image processing device 10 of the first embodiment described above, the target object detection area generation unit 130 generates an image as the target object detection area. Meanwhile, the image processing device 10 according to a second embodiment of the present disclosure is different from the image processing device 10 of the first embodiment described above in that the target object detection area generation unit 130 generates the three-dimensional point cloud as the target object detection area.

### Configuration of Image Processing Device

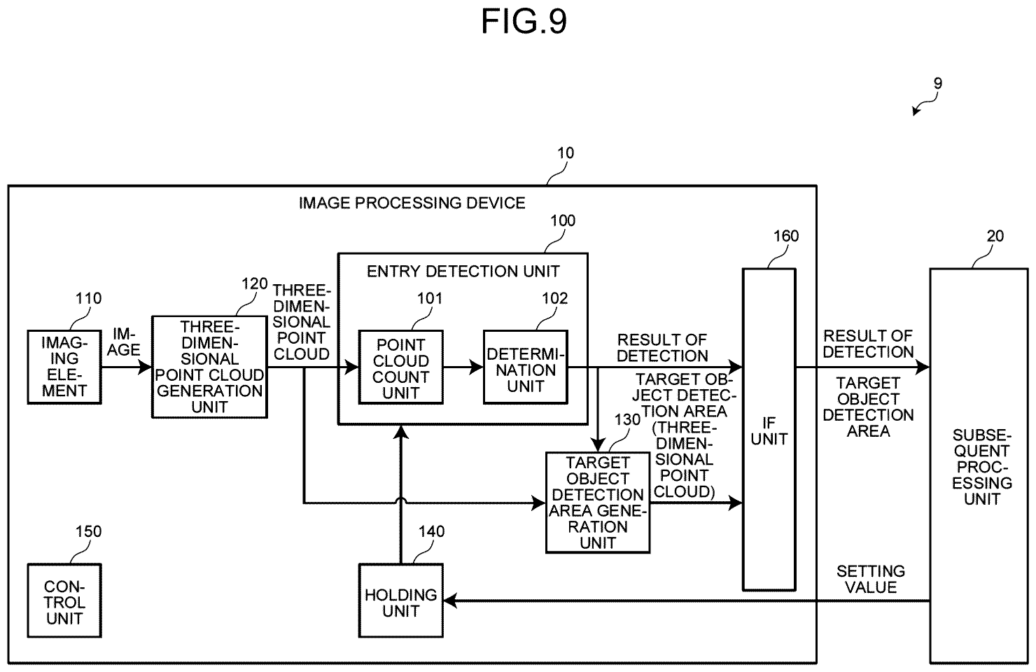

FIG. 9 is a diagram illustrating an exemplary configuration of an image processing device 10 according to the second embodiment of the present disclosure. Similarly to FIG. 2, FIG. 9 is a block diagram illustrating the exemplary configuration of the image processing device 10. The image processing device 10 of FIG. 9 is different from the image processing device 10 of FIG. 2 in that the target object detection area generation unit 130 generates the three-dimensional point cloud as the target object detection area.

As described above, the target object detection area generation unit 130 of FIG. 9 generates a three-dimensional point cloud of an area including the object 3 of the three-dimensional point cloud generated by the three-dimensional point cloud generation unit 120, as the target object detection area. In addition, the target object detection area generation unit 130 of FIG. 9 outputs the target object detection area including the generated three-dimensional point cloud, to the IF unit 160.

Note that the three-dimensional point cloud is output from the image processing device 10, and therefore, the calculation of the distance in the subsequent processing unit 20 can be omitted. This configuration makes it possible to omit the distance calculation unit 201 of the subsequent processing unit 20.

The other configurations of the image processing device 10 are similar to the configurations of the image processing device 10 according to the first embodiment of the present disclosure, and the description thereof will be omitted.

In this way, the image processing device 10 according to the second embodiment of the present disclosure generates the three-dimensional point cloud as the target object detection area, and outputs the three-dimensional point cloud to the subsequent processing unit 20. This configuration makes it possible to omit processing of calculating the distance in the subsequent processing unit 20 can be omitted.

### 3. Third Embodiment

The image processing device 10 of the first embodiment described above detects the entry of the object 3 on the basis of the number of three-dimensional point clouds corresponding to the object 3. Meanwhile, the image processing device 10 according to a third embodiment of the present disclosure is different from the image processing device 10 of the first embodiment described above in that the entry of the object 3 is detected on the basis of the number of motion vectors of the object 3.

### Configuration of Image Processing Device

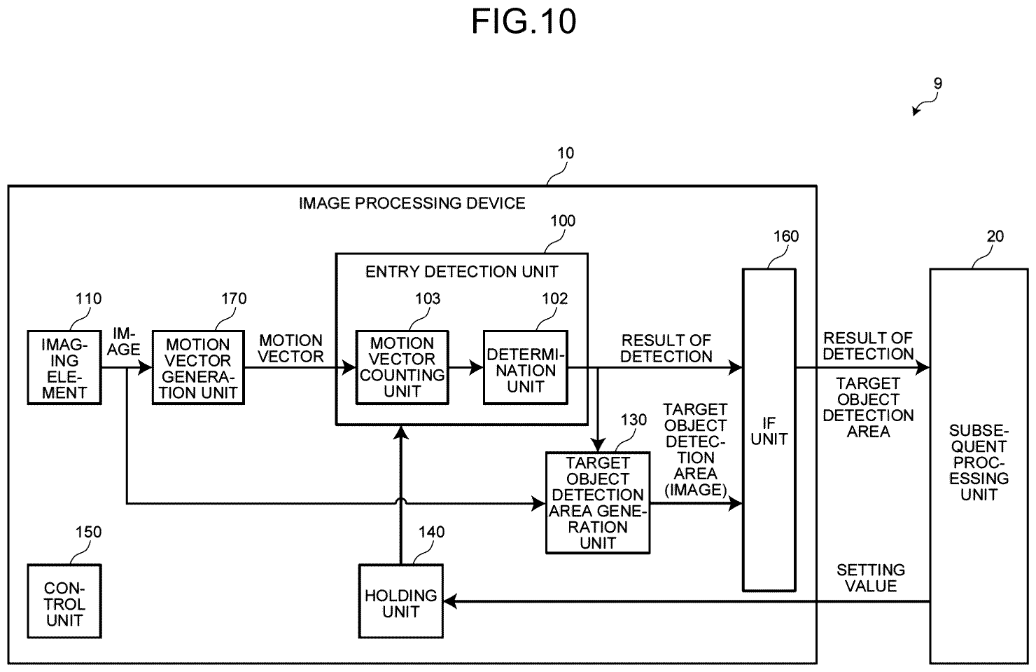

FIG. 10 is a diagram illustrating an exemplary configuration of the image processing device 10 according to the third embodiment of the present disclosure. Similarly to FIG. 2, FIG. 10 is a block diagram illustrating the exemplary configuration of the image processing device 10. The image processing device 10 of FIG. 10 is different from the image processing device 10 of FIG. 2 in that a motion vector generation unit 170 is provided instead of the three-dimensional point cloud generation unit 120. In addition, the entry detection unit 100 of the image processing device 10 of FIG. 10 includes a motion vector counting unit 103 instead of the point cloud count unit 101.

The motion vector generation unit 170 is configured to generate the motion vector as the identification information. The motion vector generation unit 170 divides the detection target area image into macro blocks, and generates the motion vector for each of the macro blocks obtained by dividing. The motion vector generation unit 170 is capable of performing block matching for each of time-series frames to generate the motion vector. The generated motion vector is output to the motion vector counting unit 103 of the entry detection unit 100. Note that motion vector generation unit 170 is an example of the “identification information generation unit” of the present disclosure.

The motion vector counting unit 103 is configured to count the number of motion vectors generated by the motion vector generation unit 170. The motion vector counting unit 103 outputs the number of the motion vectors counted, to the determination unit 102. Note that the motion vector counting unit 103 is capable of counting the number of motion vectors similar to each other in a predetermined size and direction, of the motion vectors generated by the motion vector generation unit 170. For example, the predetermined size and direction of the motion vectors can have values according to a transport speed and a transport direction of the belt conveyor 4. Limiting the motion vectors to be counted by the motion vector counting unit 103 to the predetermined size and direction makes it possible to improve the accuracy in the detection of the object 3. The holding unit 140 of FIG. 10 supplies the predetermined size and direction of the motion vector to the motion vector counting unit 103.

The determination unit 102 of FIG. 10 determines whether the object 3 has entered the detection target area on the basis of the number of motion vectors supplied from the motion vector counting unit 103. Furthermore, the determination unit 102 of FIG. 10 is capable of comparing the number of motion vectors with a predetermined threshold to determine the entry of the object 3.

The target object detection area generation unit 130 of FIG. 10 generates the target object detection area on the basis of the motion vectors to be determined in the determination unit 102.

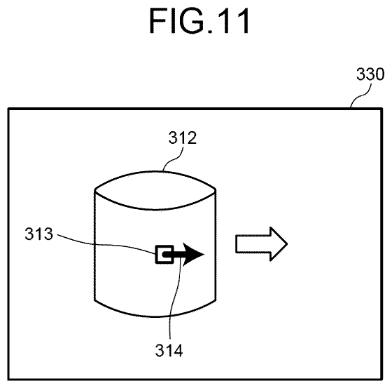

FIG. 11 is a diagram illustrating an example of the motion vector according to the third embodiment of the present disclosure. FIG. 11 is a diagram illustrating the motion vector generated by the motion vector generation unit 170. The motion vector generation unit 170 generates the motion vectors for a plurality of the macro blocks obtained by dividing an image 312 of the object 3 included in the detection target area 330. A macro block 313 and a motion vector 314 are illustrated in FIG. 11. As described above, the motion vector generation unit 170 is capable of generating the motion vector by block matching. This block matching is a method of detecting positions of corresponding macro blocks (macro blocks 313) between adjacent frames and generating, as the motion vector, a displacement between the detected positions of the macro blocks.

The other configurations of the image processing device 10 are similar to the configurations of the image processing device 10 according to the first embodiment of the present disclosure, and the description thereof will be omitted.

In this way, the image processing device 10 according to the third embodiment of the present disclosure generates the motion vector as the identification information, and detects the entry of the object 3 into the detection target area on the basis of the motion vector.

### 4. Fourth Embodiment

The image processing device 10 of the first embodiment described above detects the entry of the object 3 on the basis of the number of three-dimensional point clouds corresponding to the object 3. Meanwhile, the image processing device 10 according to a fourth embodiment of the present disclosure is different from the image processing device 10 of the first the first embodiment described above in that the entry of the object 3 is detected on the basis of a size of a specific area of the image of the object 3.

### Configuration of Image Processing Device

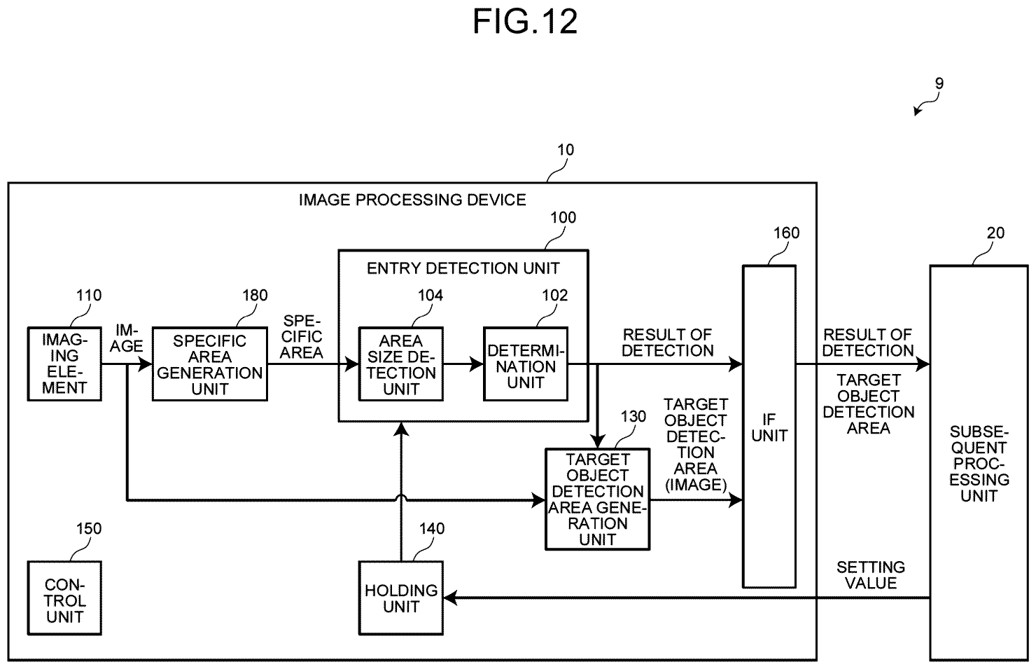

FIG. 12 is a diagram illustrating an exemplary configuration of the image processing device 10 according to the fourth embodiment of the present disclosure. Similarly to FIG. 2, FIG. 12 is a block diagram illustrating the exemplary configuration of the image processing device 10. The image processing device 10 of FIG. 12 is different from the image processing device 10 of FIG. 2 in that a specific area generation unit 180 is provided instead of the three-dimensional point cloud generation unit 120. In addition, the entry detection unit 100 of the image processing device 10 of FIG. 12 includes an area size detection unit 104 instead of the point cloud count unit 101.

The specific area generation unit 180 is configured to generate the specific area of the detection target area image, as the identification information. The specific area corresponds to an area of a specific color or an area of a specific brightness. The specific area generation unit 180 outputs the generated specific area to the area size detection unit 104 of the entry detection unit 100. Note that the specific area generation unit 180 is an example of the “identification information generation unit” of the present disclosure.

The area size detection unit 104 is configured to detect the size of the specific area generated by the specific area generation unit 180. The area size detection unit 104 outputs the detected size of the specific area to the determination unit 102. Note that the area size detection unit 104 is capable of detecting the size of an area having a color or brightness approximate to a predetermined color or predetermined brightness of the specific area generated by the specific area generation unit 180. The predetermined color and brightness in the specific area are adjustable according to the object 3. Limiting the color and brightness of the area whose size is to be detected by the area size detection unit 104 to the predetermined color or brightness makes it possible to improve the accuracy in the detection of the object 3. The holding unit 140 of FIG. 12 supplies the predetermined color and brightness to the area size detection unit 104.

The determination unit 102 of FIG. 12 determines whether the object 3 has entered the detection target area on the basis of the size of the specific area supplied from the area size detection unit 104. Furthermore, the determination unit 102 of FIG. 12 is capable of comparing the size of the specific area with a predetermined threshold to determine the entry of the object 3.

The target object detection area generation unit 130 of FIG. 12 generates the target object detection area on the basis of the specific area to be determined in the determination unit 102.

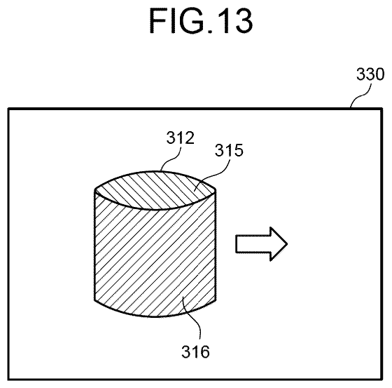

FIG. 13 is a diagram illustrating an example of the specific area according to the fourth embodiment of the present disclosure. FIG. 13 is a diagram illustrating the specific area generated by the specific area generation unit 180. The specific area generation unit 180 generates an area of a certain color or certain brightness from the image 312 of the object 3 included in the detection target area 330. In FIG. 13, areas 315 and 316 are illustrated. The area 315 and the area 316 are areas of an upper surface and a side surface of the object 3 of FIG. 13, and are areas having different colors. The specific area generation unit 180 detects such an area having a certain color or brightness and outputs the area as the specific area.

The other configurations of the image processing device 10 are similar to the configurations of the image processing device 10 according to the first embodiment of the present disclosure, and the description thereof will be omitted.

In this way, the image processing device 10 according to the third embodiment of the present disclosure generates the specific area as the identification information, and detects the entry of the object 3 into the detection target area on the basis of the size of the specific area.

Although the embodiments of the present disclosure have been described above, the technical scope of the present disclosure is not limited to the embodiments described above and various changes and alterations can be made without departing from the spirit and scope of the present disclosure. Moreover, the component elements of different embodiments and modifications may be suitably combined with each other.

Furthermore, a series of processing steps performed by the respective devices, described herein, may be implemented using any of software, hardware, and a combination of the software and the hardware. Programs constituting the software are stored in advance in, for example, recording media (non-transitory media) provided inside or outside the devices. Then, each of the programs is read into, for example, RAM upon execution by a computer and is executed by a processor such as CPU.

Furthermore, the processes having been described using the flowcharts and sequence diagrams herein may not necessarily be executed in the order illustrated. Some processing steps may be performed in parallel. In addition, an additional processing step may be employed, and some processing steps may be omitted.

In addition, the processing procedures described in the above embodiments may be regarded as a method having a series of these procedure steps, or may be regarded as a program for causing the computer to execute a series of these procedure steps or a recording medium storing the program.

As this recording medium, for example, a compact disc (CD), a minidisc (MD), a digital versatile disc (DVD), a memory card, a Blu-ray (registered trademark) disc, or the like can be used.

Note that the effects described herein are merely examples and are not limited to the description, and other effects may be provided.

Note that the present technology can also have the following configurations.
(1) An image processing device comprising an entry detection unit that detects, based on identification information being information about a part of an object in a detection target area as a target area for detection of the object, entry of the object into the detection target area.
(2) The image processing device according to the above (1), further comprising
   an identification information generation unit that generates the identification information from a detection target area image being an image of the object in the detection target area, wherein
   the entry detection unit detects the entry based on the generated identification information.
(3) The image processing device according to the above (2), wherein the identification information generation unit generates information about a three-dimensional shape of a part of the object as the identification information.
(4) The image processing device according to the above (3), wherein
   the identification information generation unit generates a three-dimensional point cloud in the detection target area image as the identification information, and
   the entry detection unit detects the entry based on the number of the generated three-dimensional point clouds.
(5) The image processing device according to the above (4), wherein the entry detection unit detects the entry based on the number of three-dimensional point clouds included in a predetermined distance range, of the generated three-dimensional point clouds.
(6) The image processing device according to the above (5), wherein the entry detection unit detects the entry by comparing the number of the generated three-dimensional point clouds with a predetermined threshold.
(7) The image processing device according to the above (6), further comprising a holding unit that holds the predetermined threshold.
(8) The image processing device according to the above (2), wherein
   the identification information generation unit divides the detection target area image into macro blocks and generates a motion vector for each of the macro blocks obtained by dividing, as the identification information, and
   the entry detection unit detects the entry based on the number of the generated motion vectors.
(9) The image processing device according to the above (2), wherein
   the identification information generation unit generates a specific area of the detection target area image, as the identification information, and
   the entry detection unit detects the entry based on a size of the generated specific area.
(10) The image processing device according to the above (9), wherein the identification information generation unit generates an area of a specific color as the specific area.
(11) The image processing device according to the above (9), wherein the identification information generation unit generates an area of a specific brightness as the identification information.
(12) The image processing device according to any one of the above (2) to (11), further comprising
   a sensor that generates the detection target area image, wherein
   the identification information generation unit generates the identification information from the detection target area image generated by the sensor.
(13) The image processing device according to any one of the above (1) to (12), further comprising a target object detection area generation unit that generates a target object detection area being information about an area of the object the entry of which is detected.
(14) The image processing device according to the above (13), wherein the target object detection area generation unit generates an image including the object, as the target object detection area.
(15) The image processing device according to the above (13), wherein the target object detection area generation unit generates a three-dimensional point cloud including the object, as the target object detection area.
(16) An image processing method comprising detecting, based on identification information being information about a part of an object in a detection target area as a target area for detection of the object, entry of the object into the detection target area.
(17) A program causing a computer to execute an entry detection procedure of detecting, based on identification information being information about a part of an object in a detection target area as a target area for detection of the object, entry of the object into the detection target area.

### REFERENCE SIGNS LIST

10 IMAGE PROCESSING DEVICE
20 SUBSEQUENT PROCESSING UNIT
100 ENTRY DETECTION UNIT
110 IMAGING ELEMENT
120 THREE-DIMENSIONAL POINT CLOUD GENERATION UNIT
130 TARGET OBJECT DETECTION AREA GENERATION UNIT
140 HOLDING UNIT
170 MOTION VECTOR GENERATION UNIT
180 SPECIFIC AREA GENERATION UNIT

1. An image processing device comprising an entry detection unit that detects, based on identification information being information about a part of an object in a detection target area as a target area for detection of the object, entry of the object into the detection target area.

2. The image processing device according to claim 1, further comprising
an identification information generation unit that generates the identification information from a detection target area image being an image of the object in the detection target area, wherein
the entry detection unit detects the entry based on the generated identification information.

3. The image processing device according to claim 2, wherein the identification information generation unit generates information about a three-dimensional shape of a part of the object as the identification information.

4. The image processing device according to claim 3, wherein
the identification information generation unit generates a three-dimensional point cloud in the detection target area image as the identification information, and
the entry detection unit detects the entry based on the number of the generated three-dimensional point clouds.

5. The image processing device according to claim 4, wherein the entry detection unit detects the entry based on the number of three-dimensional point clouds included in a predetermined distance range, of the generated three-dimensional point clouds.

6. The image processing device according to claim 5, wherein the entry detection unit detects the entry by comparing the number of the generated three-dimensional point clouds with a predetermined threshold.

7. The image processing device according to claim 6, further comprising a holding unit that holds the predetermined threshold.

8. The image processing device according to claim 2, wherein
the identification information generation unit divides the detection target area image into macro blocks and generates a motion vector for each of the macro blocks obtained by dividing, as the identification information, and
the entry detection unit detects the entry based on the number of the generated motion vectors.

9. The image processing device according to claim 2, wherein
the identification information generation unit generates a specific area of the detection target area image, as the identification information, and
the entry detection unit detects the entry based on a size of the generated specific area.

10. The image processing device according to claim 9, wherein the identification information generation unit generates an area of a specific color as the specific area.

11. The image processing device according to claim 9, wherein the identification information generation unit generates an area of a specific brightness as the identification information.

12. The image processing device according to claim 2, further comprising
a sensor that generates the detection target area image, wherein
the identification information generation unit generates the identification information from the detection target area image generated by the sensor.

13. The image processing device according to claim 1, further comprising a target object detection area generation unit that generates a target object detection area being information about an area of the object the entry of which is detected.

14. The image processing device according to claim 13, wherein the target object detection area generation unit generates an image including the object, as the target object detection area.

15. The image processing device according to claim 13, wherein the target object detection area generation unit generates a three-dimensional point cloud including the object, as the target object detection area.

16. An image processing method comprising detecting, based on identification information being information about a part of an object in a detection target area as a target area for detection of the object, entry of the object into the detection target area.

17. A program causing a computer to execute an entry detection procedure of detecting, based on identification information being information about a part of an object in a detection target area as a target area for detection of the object, entry of the object into the detection target area.
